(19) United States
(12) Patent Application Publication
(10) Pub. No.: US 2026/0203811 A1
(43) Pub. Date: Jul. 16, 2026

(54) SYSTEMS AND METHODS FOR CUSTOMER ONBOARDING USING CENTRALIZED BLOCKCHAIN

(71) Applicant: Wells Fargo Bank, N.A., San Francisco, CA (US)

(72) Inventors: Niladri Bhattacharya, Livingston, NJ (US); Frank H. Dix, New York, NY (US); Michael Charles Reynolds, Avon, CT (US)

(21) Appl. No.: 19/020,961

(22) Filed: Jan. 14, 2025

(51) Int. Cl. G06Q 40/02; G06Q 30/018; H04L 9/00

(52) U.S. Cl. CPC G06Q 40/02; G06Q 30/0185; H04L 9/50

(57) ABSTRACT

Various examples are directed to computer-implemented systems and methods for customer onboarding using a blockchain. A method includes accessing, by a first financial institution, onboarding request data from a computing device associated with a first prospective customer, the onboarding request data comprising identifier data describing the first prospective customer. The identifier data is used to identify a block of a distributed ledger comprising first data describing the first prospective customer, the first data provided to the distributed ledger by a second financial institution different than the first financial institution. A fraud screening of the first prospective customer is executed using the identifier data and the first data. Based on determining that the first prospective customer meets onboarding criteria, an account opening gateway is created for the first prospective customer, and an account is opened at the first financial institution for the customer in response to the onboarding request data.

### TECHNICAL FIELD

Embodiments described herein generally relate to computer processing systems and, for example and without limitation, to systems and methods for customer onboarding using a centralized blockchain.

### BACKGROUND

Companies such as financial institutions frequently add new clients or customers in an effort to expand their business. The current processes for screening and validating these new customers can be time consuming and expensive. Many of these new customers may already have been screened and validated by other companies or institutions in the same or similar industries. Improved systems and methods for customer onboarding are needed.

### BRIEF DESCRIPTION OF THE DRAWINGS

In the drawings, which are not necessarily drawn to scale, like numerals can describe similar components in different views. Like numerals having different letter suffixes can represent different instances of similar components. Some embodiments are illustrated by way of example, and not of limitation, in the figures of the accompanying drawings, in which;

FIG. 1A illustrates a diagram showing one example of an environment for implementing a distributed ledger for customer onboarding;

FIG. 1B is a diagram showing another example of the environment of FIG. 1A including additional details;

FIG. 2 illustrates an example of a system for customer onboarding using a centralized blockchain;

FIG. 3 illustrates an example embodiment of a computing device used for customer onboarding using a centralized blockchain;

FIG. 4 illustrates an example embodiment of a computing device used for customer onboarding using a centralized blockchain;

FIG. 5 illustrates an example embodiment of a computer-implemented method for customer onboarding using a centralized blockchain; and

FIG. 6 is a block diagram of a machine in the example form of a computer system within which a set of instructions can be executed, for causing the machine to perform any one or more of the methodologies discussed herein.

### DETAILED DESCRIPTION

In various examples, financial institutions seek to add new clients or customers in an effort to expand their business. The current processes for screening and validating these new customers can be time consuming and expensive. Many of these new customers may already have been screened and validated by other companies or institutions in the same or similar industries.

It will be appreciated that performing due diligence for customers and potential customers can consume significant resources of the financial institution. Further, this work may be duplicated for customers who patronize more than one financial institution. For example, when a customer approaches a first financial institution, the first financial institution may perform various due diligence operations regarding the customer. If the customer then approaches a second financial institution, the second financial institution may also perform the same or similar due diligence operations with respect to the customer. It will also be appreciated that financial institutions do not all evaluate due diligence in the same ways, and that as a partially manual process, due diligence may yield different results for different institutions, respectively. This means that whereas the due diligence process of one institution may detect fraud during the onboarding of a commercial customer, for example, another institution may not detect the fraud. Collective learning from the due diligence processes of all these financial institutions may thereby enhance the quality of onboarding outcomes for all of the financial institutions.

Computing technology may be used to automate and store the results of financial institution customer due diligence and make the stored results available to multiple different financial institutions. Attempting to utilize routine and conventional computing tools for this purpose, however, generates several challenges.

In some examples, due diligence data collected by various financial institutions may be stored to a block chain or other distributed ledger. In such an arrangement, due diligence data about potential customers may be included in blocks of the distributed ledger.

This subject matter provides a system for customer onboarding using a centralized blockchain. The system may include a computer comprising at least one processor and a data storage device in communication with the at least one processor. In various examples, the data storage device comprises instructions thereon that, when executed by the at least one processor, causes the at least one processor to access, by a first financial institution, onboarding request data from a computing device associated with a first prospective customer, the onboarding request data comprising identifier data describing the first prospective customer. The identifier data is used to identify a block of a distributed ledger comprising first data describing the first prospective customer, the first data provided to the distributed ledger by a second financial institution different than the first financial institution. A fraud screening of the first prospective customer is executed using the identifier data and the first data. Based on determining that the first prospective customer meets onboarding criteria, an account opening gateway is created for the first prospective customer, and an account is opened at the first financial institution for the first prospective customer in response to the onboarding request data using the account opening gateway. In some examples, the distributed ledger is a tiered distributed ledger.

In various examples, this subject matter provides for a proxy account for customers with accounts at partner banks. In some embodiments, an account is automatically created at a financial institution without direct contact between the financial institution and the customer. This subject matter provides for an enhanced experience for a potential customer, such as a fund manager, in one example. This system provides for a potential customer to choose a financial institution and type of account to open, in some examples. The potential customer opts-in to an automatic account opening, in some examples. In some examples, the financial institution opts-in to the automatic account opening. The potential customer then uses an interface of the present system to provide identifier data, such as an android identifier, name, username, EIN/SSN, or the like. In some examples, a back-end service finds the potential customer on the blockchain using the identifier data. After finding the potential customer on the blockchain, this system performs a fraud screening, such as a sift method to identify and verify the potential customer. Once the potential customer has been verified, a back-end service may create a bank account opening gateway, and then automatically open an account for the potential customer using the identifier data without needing to redirect the user, in one example. In another example, the potential customer is directed to a website or application of the financial institution for finalizing account opening.

While the above system is demonstrated for fund manager potential customers, other potential customers of financial institutions, such as consumer banking, credit card, etc., may be served by this system. In various examples, onboarding requests for different financial products or account types have different requirements. The system having this back-end service may be adapted to do different onboardings for different products and account types, in various embodiments. In some embodiments, this system verifies a potential customer to a prescribed level, thereby avoiding the need to do any new data collection if a lower account level fraud verification requirement is detected. In some examples, this system may incorporate timing aspects, such as using a time-to-live (TTL) for the verification stored in a block of the distributed ledger. The system may provide a notification to the financial institution when a block could not be created or when a potential customer had some red flag or high suspicion that indicates potential fraud, in some embodiments. In some examples, this notification of potential fraud may be instantiated as a side chain or other type of block in the ledger to provide notice to future institutions that attempt to screen this potential customer. In various embodiments, a block indicates whether the potential customer is verified or unverified.

This system provides a number of technical benefits. For example, this system provides for automated account creation without direct communication between customer and bank. In addition, this system automates and accelerates potential customer validation and onboarding for multiple financial institutions with access to the distributed ledger. In various examples, the system provides for transferrable onboarding, using a centralized blockchain to leverage what other financial institutions have done with respect to onboarding of potential customers, so financial institutions do not have to repeat the screening before onboarding. In some examples, this system provides for screening and validation for a life cycle of a client, onboarding different products for the client at the client's request. In various examples, the system updates the ledger with the results of the customer screening, such as by using tiers in the ledger as described herein. In some examples, the system provides information on potential customers whose identity cannot be verified, or who, for any other reason, cannot be onboarded.

If a financial institution is ending a relationship with a customer, that information along with the reasoning for the action may be added to a tier of the ledger, in various examples. In some examples, this action may trigger a threat perception for a potential customer. This system provides for a centralized blockchain for an inter-banking network central monitoring tool, in various embodiments. In some examples, the system provides for centralized financial institution customer monitoring, and further provides centralized system aggregation across blocks in a distributed ledger. The federal banking system may have monitoring access to the system, such that the fed can see which banks are reacting to the information in the ledger, in some examples. In various examples, the present system provides a centralized back end service, and if financial institutions are at a different level, they can override the system to add additional steps or blocks. In some examples, financial institutions can read the blocks on a first tier, and can add blocks at their own proprietary level or tier. For example, levels may be institution-specific, such that a financial institution may write back to the block at a chosen level after screening a potential customer for a particular proprietary product. In various examples, analytics may be performed on data encoded in various blocks, to help financial institutions establish new metrics for evaluating the risk of onboarding a potential customer or client. Data analytics is a process of using data to identify patterns and trends, and then using those insights to solve problems and make decisions. In the present system, analytics be used to improve strategy and decision-making during the onboarding process, in various embodiments. Specifically, information gathered on the identity and onboarding status of a given customer or client across multiple financial institutions may help individual financial institutions assess the onboarding risk of a given customer or client with greater accuracy, in some examples.

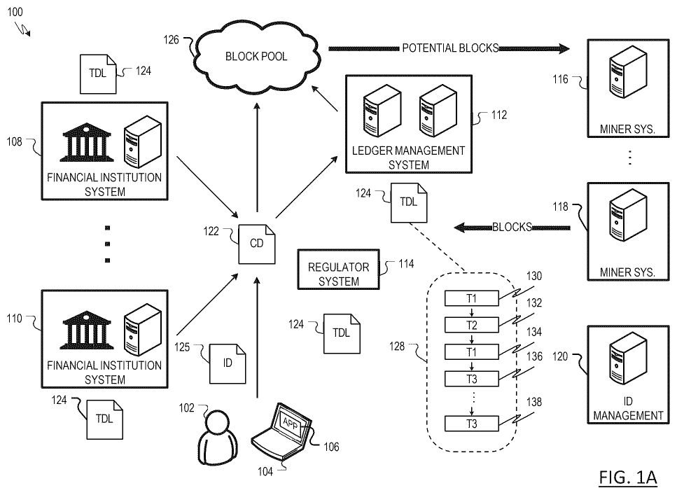

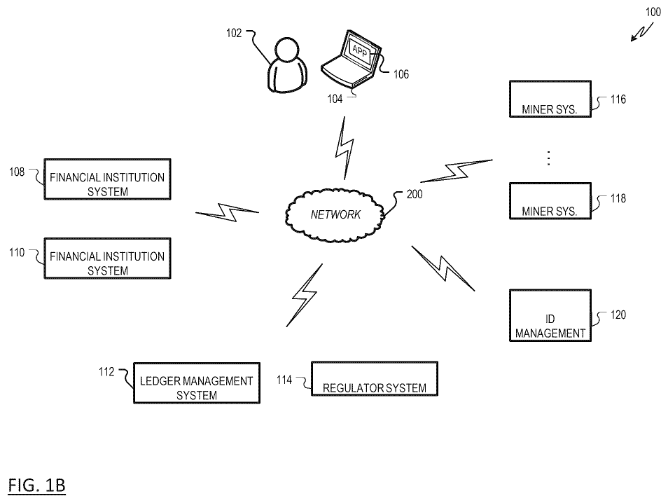

FIG. 1A is a diagram showing one example of an environment 100 for implementing a distributed ledger 124, such as a tiered ledger. The environment 100 shows financial institution computing systems 108, 110 and a ledger management system 112. It will be appreciated that various implementations of the environment 100 may include more or fewer systems than are shown in FIG. 1A. For example, the environment 100 may include more than two financial institution systems, more than one ledger management system, and/or the like.

In this example, the distributed ledger 124 is used to store data describing customers and prospective customers of one or more financial institutions associated with the respective financial institution computing systems 108, 110. An example user 102 associated with a customer is shown. The user 102 may communicate with other portions of the environment 100 using a user computing device 104. The user computing device 104 may be any suitable computing device or devices such as, for example, a smart phone, a tablet computer, a laptop computer, a smart watch, and the like. The user computing device 104 may comprise input/output (I/O) devices for providing a user interface (UI) to the user 102. In some examples, user computing device 104 executes an application 106 that facilitates interaction with the other components of the environment 100. In some examples, the application 106 is a web browser that communicates with one or more of the other systems 108, 110, 112, 116, 118, 120 of the environment 100 via a web server or similar arrangement. In some examples, the user 102 provides unique identifier data describing a customer or potential customer associated with the user. The financial institution system 108, 110 and/or regulator system 114 may utilize unique identifier data 125 received from the user 102 to identify one or more blocks of the tiered distributed ledger 124 including customer data describing the customer or potential customer represented by the user 102.

Financial institution systems 108, 110 may be implemented by financial institution such as, for example, commercial banks, investment banks, issuers of credit cards or other similar financial instruments, and/or the like. The financial institution systems 108, 110 may comprise one or more computing devices, such as servers and/or the like. A single financial institution system 108, 110 may be implemented at a single geographic location and/or across multiple geographic locations. In some examples, a financial institution may implement a financial institution system 108, 110 in whole or in part using a cloud deployment such as according to an infrastructure as a service (IaaS), platform as a service (PaaS) or similar arrangement.

The ledger management system 112 may be implemented by an entity that acts as a manager for the distributed ledger 124. For example, the entity implementing the ledger management system 112 may be a financial institution, a consortium of financial institutions, and/or the like. The ledger management system 112 may comprise one or more computing devices, such as servers and/or the like. The ledger management system 112 may be implemented at a single geographic location and/or across multiple geographic locations. Also, although only one ledger management system 112 is shown in FIG. 1A, it will be appreciated that the distributed ledger 124, as described herein, may be managed by multiple different ledger management systems 112. For example, different ledger management systems 112 may manage different tiers of the tiered distributed ledger 124.

A regulator system 114 may be a computing system implemented by a public agency or other financial regulator. A regulator entity may utilize the regulator system 114 to access the distributed ledger 124, such as a tiered distributed ledger. The regulator entity may examine the distributed ledger, for example, to identify transactions and/or other potentially regulated behavior by one or more financial institutions and/or customers thereof. The regulator system 114 may comprise one or more computing devices, such as servers and/or the like. The regulator system 114 may be implemented at a single geographic location and/or across multiple geographic locations. Also, although only one regulator system 114 is shown in FIG. 1A, it will be appreciated that the environment 100 may include multiple regulator systems such as the regulator system 114. For example, different public entities for different jurisdictions may implement regulator systems similar to the regulator system 114.

The tiered distributed ledger 124 may be used to store customer data describing customers or potential customers of the financial institutions. An example diagram 128 of the tiered distributed ledger 124 indicates blocks 130, 132, 134, 136, 138. Each block 130, 132, 134, 136, 138 is associated with a tier, where the tier of a block describes the data that is stored in the block and an encryption status of the block, if any. In this example, three tiers are shown. For example, blocks 130 and 134 are tier 1 blocks. Block 132 is a tier 2 block. Blocks 136, 138 are tier 3 blocks.

Customer data stored at the tiered distributed ledger 124 may be generated by financial institutions associated with the financial institution systems 108. When a financial institution generates customer data 122 describing a customer or prospective customer, the financial institution, using its associated financial institution system 108, 110 may provide the customer data 122 to the ledger management system 112. In some examples, the financial institution system 108, 110 cryptographically signs the customer data 122 to verify the identity of the financial institution providing the customer data 122. The financial institution system 108, 110 may provide a unique identifier of the customer or potential customer with the customer data 122. The unique identifier may be any identifier that may uniquely identify an individual customer or customer or entity. In some examples, the unique identifier is or includes a Legal Entity Identifier (LEI).

The ledger management system 112 may receive the customer data 122 and determine whether the customer data has been received from an entity that is authorized to write to the tiered distributed ledger 124. If the ledger management system 112 determines that the customer data 122 was received from a financial institution that is authorized to write to the tiered distributed ledger 124, it may determine a tier associated with the customer data 122. In some examples, the financial institution system 108, 110 may include tier data with the customer data 122. The tier data may describe a tier to which the customer data is to be written. In some examples, the ledger management system 112 may determine the tier level of customer data 122 based on the customer data 122. If the tier level for the customer data 122 corresponds to a tier that is to be encrypted, the ledger management system 112 may encrypt the customer data 122 using one or more cryptographic keys.

Customer data 122 may be recorded at the tiered distributed ledger 124 as a block and/or as part of a block. In some examples, the financial institution system 108, 110 digitally signs customer data 122 to form a potential block. Accordingly, the customer data 122 is provided to the ledger management system 112 as a potential block. In other examples, the ledger management system 112 digitally signs customer data 122 to form a potential block upon verifying that the financial institution associated with the financial institution system 108, 110 is authorized to write to the tiered distributed ledger 124. In some examples, the ledger management system 112 consolidates customer data describing multiple different customers and/or received from multiple different financial institution systems 108, 110 into a common potential block. In some examples, the cryptographic signature for a block or potential block is generated considering data from a prior transaction at the tiered distributed ledger 124 so as to set an order of blocks. After a potential block is digitally signed, it may be broadcast to other systems 108, 110, 112, 114 that maintain copies of the tiered distributed ledger 124.

In some examples, broadcasting a potential block of the tiered distributed ledger 124 includes providing the potential block to a block pool 126. The block pool 126 may be maintained by one or more of the systems 108, 110, 112, 114, and/or devices 104 that are parties to the tiered distributed ledger 124 and/or may be implemented by one or more other systems, such as by one or more miner systems 116, 118. In some examples, broadcasting may be performed utilizing a broadcasting circuit. The broadcasting circuit may be a component of the system 108, 110, 112, 114, 116, 118, 120 performing the broadcast and may be used by the respective system to communicate the potential block or other data to other respective systems. In some examples, a broadcasting circuit includes a network interface device or other similar suitable hardware.

Miner systems 116, 118 may generate blocks for the tiered distributed ledger 124 using potential blocks from the block pool 126. A miner system 116, 118 may include any suitable computing device or devices such as, for example, one or more desktop computers, one or more laptop computers, one or more servers, and the like. In some examples, a miner system 116, 118 includes specialized hardware for quickly performing cryptographic functions such as, for example, high speed graphics processing units (GPUs), an Application Specific Integrated Circuit (ASIC) optimized for cryptographic operations, and/or the like.

A block generated by a miner system 116, 118 may include customer data generated by one or more of the financial institution systems 108, 110 and a unique identifier of the customer. If the block is part of a tier in which data is to be encrypted, the customer data included in the block may be encrypted and, therefore, unreadable to those who do not possess the proper cryptographic key data. On the other hand, if the block is part of the tier in which data is unencrypted or in the clear, the customer data may not be encrypted. For example, although blocks of the tiered distributed ledger 124 may be digitally signed, as described herein, the customer data incorporated into blocks that are unencrypted or in the clear may be readable by parties in possession of the tiered distributed ledger 124. A miner system 116, 118 may digitally sign the block of transaction records. In some examples, the miner system's cryptographic signature may be determined based on content from a prior block at the tiered distributed ledger 124 (e.g., the most recent block added to the tiered distributed ledger 124).

In addition to digitally signing a block, the miner systems 116, 118 may generate a proof-of-work for the block. The proof-of-work for the block may involve performing a cryptographic operation that takes time to complete. In some examples, the proof-of-work may involve adding nonce data to all or a portion of the block such that the cryptographic signature of the block has a predetermined property (e.g., a predetermined number of leading zeros, and/or the like). It may not be practical to deterministically generate the proof-of-work, so the miner systems 116, 118 may repeatedly test nonce data with the cryptographic function used to generate the cryptographic signature until nonce data is found that, when used with the cryptographic function of the cryptographic signature, generates a cryptographic signature having the predetermined properties.

The first miner system 116, 118 to generate a cryptographic signature having the predetermined properties may broadcast its version of the block, including the cryptographic signature or other proof-of-work, to the parties to the tiered distributed ledger 124. The parties may add the newly received block to the tiered distributed ledger 124. In some examples, the tiered distributed ledger 124 may be implemented with rules for resolving block conflicts. For example, if two miner systems 116, 118 solve a block at or near the same time, some of the parties to the tiered distributed ledger 124 may first receive a new block generated by miner system 116 while other parties may first receive a new block generated by miner system 118. In such a case, for example, the parties to the tiered distributed ledger 124 may accept as accurate the block chain branch having the most blocks.

A miner system 116, 118 that successfully generates a block may be compensated by the other parties to the tiered distributed ledger 124. For example, the parties who requested the transaction records included in a block may pay a transaction charge to the miner system 116, 118 when a block is completed.

Financial institution systems 108, 110, regulators system 114, and/or other parties may utilize the tiered distributed ledger 124 to retrieve customer data. For example, a potential customer may approach a financial institution associated with the financial institution system 108 desiring to purchase a financial product or service. The financial institution system 108 may receive unique identifier data for the potential customer. The financial institution system 108 may use the unique identifier data for the potential customer to identify one or more blocks at the tiered distributed ledger 124 comprising customer information about the potential customer. For blocks that are part of an unencrypted or clear tier of the tiered distributed ledger 124, the financial institution system 108 may read the customer data and utilize it to verify the identity of the potential customer and receive other customer information. In some examples, the financial institution system 108 may verify the block to ensure that it is properly a part of the tiered distributed ledger. This may include, for example, recalculating a cryptographic signature of the block in view of the content of one or more other blocks in the tiered distributed ledger 124.

If the tiered distributed ledger comprises encrypted-tier blocks describing the potential customer (e.g. as indicated by the unique customer identifier data), the financial institution system 108 may query the ledger management system 112 to facilitate decryption. The ledger management system 112 may determine if the financial institution system 108 is authorized to decrypt the block or blocks. In some examples, the financial institution system 108 may be authorized if it institutes a payment transaction for access and/or if the financial institution system 108 possesses a subscription to the appropriate tier. The ledger management system 112 may provide cryptographic key data to the financial institution system 108. Financial institution system 108 may utilize the cryptographic key data to decrypt customer data from the appropriate block or blocks. Any suitable cryptographic key data or cryptographic technique may be used such as, for example, Rivest-Shamir-Adleman (RSA) or another suitable public-key crypto system.

In some examples, the financial institution system 108 provides the encrypted block and/or an indication of it to the ledger management system 112. The ledger management system 112 may decrypt the customer data at the indicated block or blocks and provide the decrypted block or blocks to the financial institution system 108. In some examples, the decrypted block or blocks are transmitted to the financial institution system 108 utilizing a secure communication session. For example, the ledger management system 112 may encrypt the block data before sending it to the financial institution system according to the secure communication session. The financial institution system 108 may utilize cryptographic key data to decrypt the block data according to the secure communication session.

In various examples, an identity management system 120 may be used to track the identity of participants in the tiered distributed ledger 124 such as, for example, financial institution systems 108, 110, the regulator system 114, and one or more users associated with customers, such as user 102. The identity management system 120 may be implemented using any suitable computing device or devices such as, for example, one or more services at a single location and/or distributed at multiple geographic locations. The identity management system 120 may be implemented using an on-premises arrangement and/or using a cloud deployment such as according to IaaS, PaaS, or a similar arrangement.

In some examples, an entity implementing one or more of the computing devices or systems 108, 110, 112 may prove its identity to the identity management system 120, for example, by providing identifying information to the identity management system 120 and/or an identity management entity associated with the identity management system 120. Identifying information provided by a plan participant to the identity management system 120 may include, for example, a name, previous names, an address, a Social Security number or other government identification number, a date of birth, etc. In some examples, an entity may provide documents to the identity management system 120 such as, for example, a birth certificate, a Social Security card, driver's license, or other government-issued identification. In some examples, a user provides the identity management system 120 (and/or the implementing identity management entity) with hard copies of one or more identity-proving documents.

When a party has proven its identity to the identity management system 120, the identity management system 120 may store a public verification key for the party. In some examples, the party (or a computing system thereof) generates the public verification key and provides it to the identity management system 120, which may store the public verification key. In other examples, the identity management system 120 may generate a public/private key pair for the party and store the public verification key in association with identity information describing the user 102. In some examples, the identity management system 120 may also store unique identifier data associated with a particular customer or potential customer.

When a financial institution system 108, 110 or regulator system 114 is to demonstrate its authorization to either read to or right from the tiered distributed ledger, it may provide identifying information to the ledger management system 108. The identity management system 120 may determine whether it has stored identity information for the financial institution system 108, 110 or regulator system 114 previously. If the identity management system 120 already has a public verification key stored in association with financial institution system 108, 110 or regulator system 114, the identity management system 120 may provide the public verification key to the ledger management system 112. The plan sponsor system 108 may use the public verification key to verify that the financial institution system 108, 110 or regulator system 114 is authorized to write to the tiered distributed ledger and/or read encrypted tier blocks from the tiered distributed ledger 124.

In some examples, customers, via customer users 102, may similarly use the identity management system 120. For example, the user 102 may provide identity information describing the user 102 and/or a customer entity associated with the user 102 to a financial institution system 108, 110. The financial institution system 108, 110 may provide the identifying information to the identity management system 120.

The identity management system 120 may determine whether it has stored identity information for the user 102 or customer associated therewith previously. For example, if the user 102 or customer associated therewith has a retirement plan account opened through a different plan sponsor, then the identity management system 120 may already have a public verification key stored for the user 102 or customer associated therewith. If the identity management system 120 already has a public verification key stored in association with the user 102 or customer associated therewith, the identity management system 120 may provide the public verification key to the plan sponsor system 108. The plan sponsor system 108 may use the public verification key for transactions involving the user 102 or customer associated therewith. If the identity management system 120 does not have a public verification key stored in association with the user 102 or customer associated therewith, the user 102 or customer associated therewith may be prompted to generate and/or store a public verification key at the identity management system 120, as described herein. The identity management system 120 may provide the public verification key to the plan sponsor system 108, which may use the public verification key for transactions involving the user 102 or customer associated therewith.

FIG. 1B is a diagram showing another example of the environment 100 including additional details. In the example of FIG. 1B, the financial institution systems 108, 110, ledger management system 112, regulator system 114, miner systems 116, 118, identity management system 120 are in communication with one another via a network 200. The network 200 may be or comprise any suitable network element operated according to any suitable network protocol. For example, one or more portions of the network 200 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, another type of network, a combination of two or more such networks, and so forth.

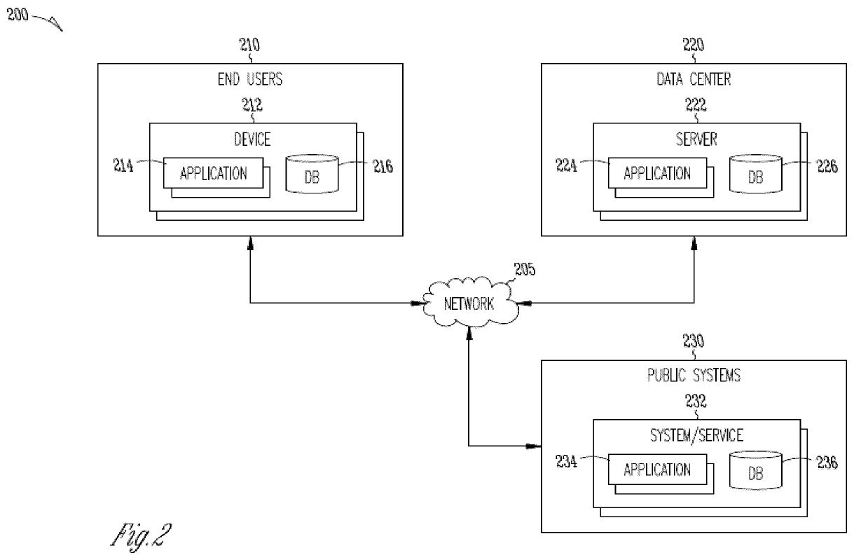

FIG. 2 illustrates an exemplary infrastructure for providing a system of the present subject matter. The infrastructure may comprise a distributed system 200 including a computing system that may include a client-server architecture or cloud computing system. Distributed system 200 may have one or more end users 210. An end user 210 may have various computing devices 212, which may be a machine 600 as described below. The end-user computing devices 212 may comprise applications 214 that are either designed to execute in a stand-alone manner, or interact with other applications 214 located on the device 212 or accessible via the network 205. These devices 212 may also comprise a data store 216 that holds data locally, the data being potentially accessible by the local applications 214 or by remote applications.

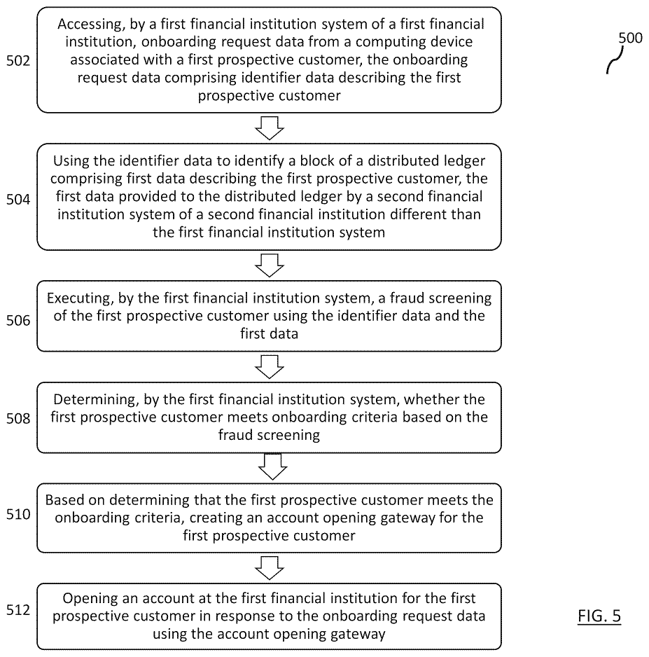

The system 200 may also include one or more data centers 220. A data center 220 may be a server 222 or the like associated with an entity that an end user 210 may interact with. The server 222 or other portions of the distributed system may create and manage the system for customer onboarding using a centralized blockchain, such as by performing operations including the method of FIG. 5, in various embodiments. The entity may be a computer service provider, as may be the case for a cloud services provider, or it may be a consumer product or service provider, such as a financial institution. The data center 220 may comprise one or more applications 224 and databases 226 that are designed to interface with the applications 214 and databases or data store 216 of end-user devices 212. Data centers 220 may represent facilities in different geographic locations where the servers 222 may be located. Each of the servers 222 may be in the form of a machine(s) 600.

The system 200 may also include publicly available systems 230 that comprise various systems or services 232, including applications 234 and their respective databases 236. Such applications 234 may include news and other information feeds, search engines, social media applications, and the like. The systems or services 232 may be provided as comprising a machine(s) 600.

The end-user devices 212, data center servers 222, and public systems or services 232 may be configured to connect with each other via the network 205, and access to the network by machines may be made via a common connection point or different connection points, e.g., a wireless connection point and a wired connection. Any combination of common or different connections points may be present, and any combination of wired and wireless connection points may be present as well. The network 205, end users 210, data centers 220, and public systems 230 may include network hardware such as routers, switches, load balancers and/or other network devices.

Other implementations of the system 200 are also possible. For example, devices other than the client devices 212 and servers 222 shown may be included in the system 200. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 222.

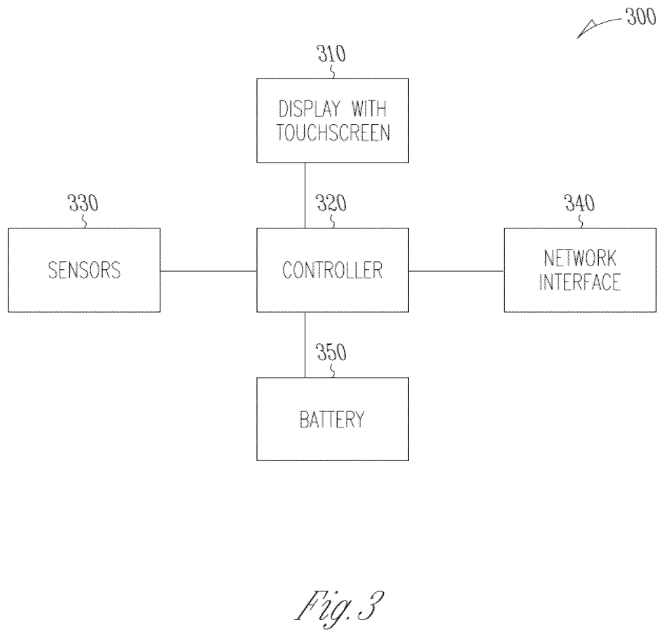

FIG. 3 illustrates an embodiment of computing device 300 used by a user for customer onboarding using a centralized blockchain. In the depicted embodiment, the computing device 300 includes a display with a touchscreen 310 interfaced with a controller or processor 320. The controller or processor 320 is electrically connected to one or more sensors 330, a network interface 340, and a battery 350 to supply power to the computing device 300, in various embodiments.

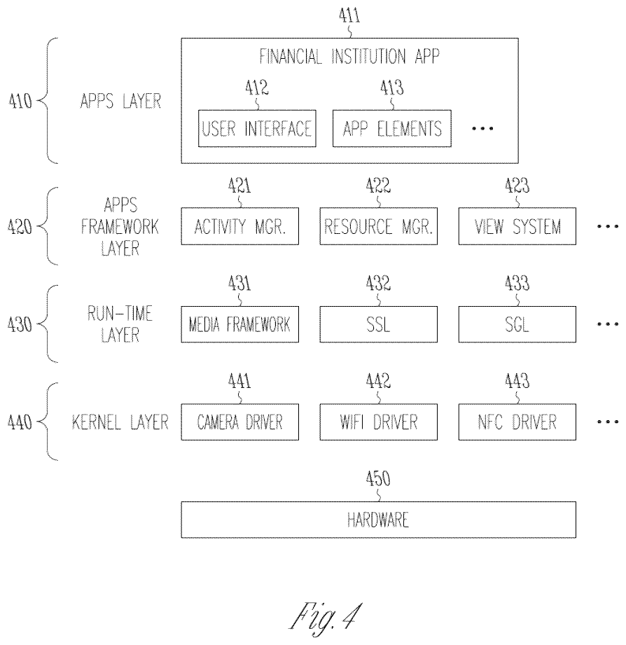

FIG. 4 illustrates an embodiment of a computing device 400 with a financial institution application 411. In various embodiments, the computing device 400 includes a mobile computing device such as a cellular telephone or smart phone. The depicted embodiment illustrates one example of software architecture executed on hardware 450, including one or more processors of the computing device 400. FIG. 4 is merely a non-limiting example of a software architecture and many other architectures can be implemented to facilitate the functionality described herein.

The representative hardware 450 comprises one or more processing units having associated executable instructions. Executable instructions represent the executable instructions of the software architecture, including implementation of the methods, modules, and components of this subject matter. Hardware 450 also includes memory and/or storage modules, which also have executable instructions.

In the example architecture of FIG. 4, the software can be conceptualized as a stack of layers where each layer provides particular functionality. For example, the software can include layers such as an operating system, libraries, frameworks/middleware, applications and presentation layer. Other software architectures can include additional or different layers. The operating system can manage hardware resources and provide common services. The overall system can include, for example, a kernel layer 440, run-time layer 430, application framework layer 420 and application layer 410. The kernel layer 440 can act as an abstraction layer between the hardware and the other software layers. For example, the kernel layer 440 can be responsible for memory management, processor management (e.g., scheduling), component management, networking, security settings, and so on. The drivers can be responsible for controlling or interfacing with the underlying hardware. For instance, the drivers can include display drivers, camera drivers 441, Bluetooth® drivers, flash memory drivers, serial communication drivers (e.g., Universal Serial Bus (USB) drivers), Wi-Fi® drivers 442, near field communication (NFC) drivers 443, audio drivers, power management drivers, and so forth depending on the hardware configuration.

The run-time layer 430 can include a media framework 431, a secure sockets layer (SSL) 432 and a secure group layer (SGL) 433, in various embodiments. The application framework layer 420 can include an activity manager 421, a resource manager 422, and a view system application 423, in various embodiments. The application layer 410 can include built-in applications and/or third party applications. Examples of representative built-in applications can include, but are not limited to, a contacts application, a browser application, a book reader application, a location application, a media application, and/or a messaging application. Third party applications can include any of the built in applications as well as a broad assortment of other applications. In a specific example, the third party application (e.g., an application developed using the Android™ or iOS™ software development kit (SDK) by an entity other than the vendor of the particular platform) can be mobile software running on a mobile operating system such as iOS™, Android™, Windows® Phone, or other mobile operating systems. In this example, the third party application can invoke application programming interface (API) calls provided by the operating system to facilitate functionality described herein. A financial institution application 411 can implement the functionality of customer onboarding using a centralized blockchain, in one embodiment. The customer onboarding application can be a built-in or third party application, and can include a user interface 412 and application elements 413 in various embodiments.

The applications in application layer 410 can utilize built in operating system functions (e.g., kernel, services and/or drivers), libraries, frameworks and middleware to create user interfaces to interact with users of the system. Alternatively, or additionally, in some systems interactions with a user can occur through a presentation layer. In these systems, the application/module “logic” can be separated from the aspects of the application/module that interact with a user.

FIG. 5 illustrates an example embodiment of a computer-implemented method for customer onboarding using a centralized blockchain. The method 500 includes accessing, by a first financial institution system of a first financial institution, onboarding request data from a computing device associated with a first prospective customer, the onboarding request data comprising identifier data describing the first prospective customer, at step 502. At step 504, the identifier data is used to identify a block of a distributed ledger comprising first data describing the first prospective customer, the first data provided to the distributed ledger by a second financial institution system of a second financial institution different than the first financial institution system. A fraud screening of the first prospective customer is executed by the first financial institution system using the identifier data and the first data, at step 506. At step 508, the first financial institution system determines whether the first prospective customer meets onboarding criteria based on the fraud screening. Based on determining that the first prospective customer meets the onboarding criteria, an account opening gateway is created for the first prospective customer, at step 510. At step 512, an account is opened at the first financial institution for the first prospective customer in response to the onboarding request data using the account opening gateway.

According to various examples, the distributed ledger is a tiered distributed ledger. The method may further include using the identifier data to identify a first block of the tiered distributed ledger, and verifying the first block of the distributed ledger, in some examples. In further examples, the method also includes using the identifier data to identify a second block of the distributed ledger comprising second data describing the first prospective customer different than the first data, the second data being encrypted, accessing first cryptographic key data associated with the second block of the distributed ledger, and decrypting the second data using the first cryptographic key data. The method may also include executing, by the first financial institution system, a fraud screening of the first prospective customer using the first data and the second data, in various examples. In some examples, the method also includes providing the first prospective customer with an interface to select a financial institution from a list of a plurality of financial institutions, the plurality of financial institutions including the first financial institution and the second financial institution. In various examples, the first prospective customer is a fund manager, a consumer banking customer, or a credit card customer.

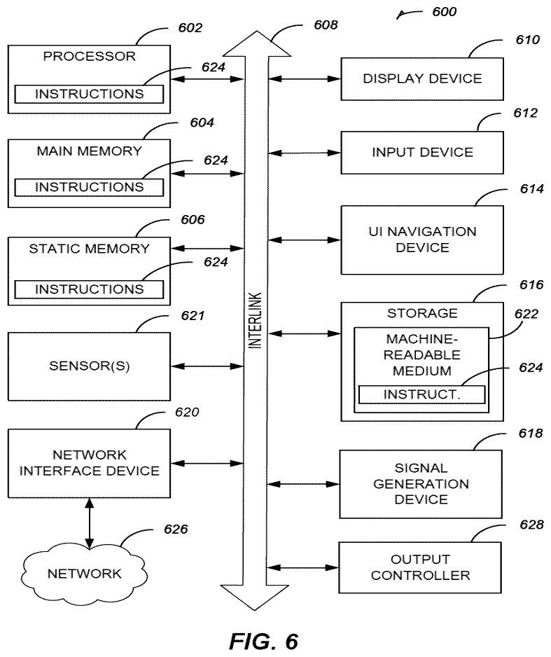

FIG. 6 illustrates generally an example of a block diagram of a machine 600 upon which any one or more of the techniques (e.g., methodologies) discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the execution units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of this subject matter to solve the challenges and provide the benefits discussed herein, among others.

Example 1 is a computer-implemented method including accessing, by a first financial institution system of a first financial institution, onboarding request data from a computing device associated with a first prospective customer, the onboarding request data comprising identifier data describing the first prospective customer, using the identifier data to identify a block of a distributed ledger comprising first data describing the first prospective customer, the first data provided to the distributed ledger by a second financial institution system of a second financial institution different than the first financial institution system, executing, by the first financial institution system, a fraud screening of the first prospective customer using the identifier data and the first data, determining, by the first financial institution system, whether the first prospective customer meets onboarding criteria based on the fraud screening, based on determining that the first prospective customer meets the onboarding criteria, creating an account opening gateway for the first prospective customer, and opening an account at the first financial institution for the first prospective customer in response to the onboarding request data using the account opening gateway.

In Example 2, the subject matter of Example 1 optionally includes wherein the distributed ledger is a tiered distributed ledger.

In Example 3, the subject matter of Example 2 optionally further includes using the identifier data to identify a first block of the tiered distributed ledger, and verifying the first block of the distributed ledger.

In Example 4, the subject matter of Example 3 optionally further includes using the identifier data to identify a second block of the distributed ledger comprising second data describing the first prospective customer different than the first data, the second data being encrypted, accessing first cryptographic key data associated with the second block of the distributed ledger, and decrypting the second data using the first cryptographic key data.

In Example 5, the subject matter of Example 4 optionally further includes executing, by the first financial institution system, a fraud screening of the first prospective customer using the first data and the second data.

In Example 6, the subject matter of Example 1 optionally further includes providing the first prospective customer with an interface to select a financial institution from a list of a plurality of financial institutions, the plurality of financial institutions including the first financial institution and the second financial institution.

In Example 7, the subject matter of Example 1 optionally further includes performing analytics on data encoded in at least one block of the distributed ledger to establish a new metric for evaluating risk of onboarding prospective customers.

Example 8 is a system including a computer comprising at least one processor and a data storage device in communication with the at least one processor, wherein the data storage device comprises instructions thereon that, when executed by the at least one processor, causes the at least one processor to: access, by a first financial institution, onboarding request data from a computing device associated with a first prospective customer, the onboarding request data comprising identifier data describing the first prospective customer, use the identifier data to identify a block of a distributed ledger comprising first data describing the first prospective customer, the first data provided to the distributed ledger by a second financial institution different than the first financial institution, execute, by the first financial institution, a fraud screening of the first prospective customer using the identifier data and the first data, determine, by the first financial institution, whether the first prospective customer meets onboarding criteria based on the fraud screening, based on determining that the first prospective customer meets the onboarding criteria, create an account opening gateway for the first prospective customer, and open an account at the first financial institution for the first prospective customer in response to the onboarding request data using the account opening gateway.

In Example 9, the subject matter of Example 8 optionally includes wherein the distributed ledger is a tiered distributed ledger.

In Example 10, the subject matter of Example 9 optionally includes wherein the at least one processor is further configured to use the identifier data to identify a first block of the tiered distributed ledger, and verify the first block of the distributed ledger.

In Example 11, the subject matter of Example 10 optionally includes wherein the at least one processor is further configured to use the identifier data to identify a second block of the distributed ledger comprising second data describing the first prospective customer different than the first data, the second data being encrypted, access first cryptographic key data associated with the second block of the distributed ledger, and decrypt the second data using the first cryptographic key data.

In Example 12, the subject matter of Example 11 optionally includes wherein the at least one processor is further configured to execute, by the first financial institution, a fraud screening of the first prospective customer using the first data and the second data.

In Example 13, the subject matter of Example 8 optionally includes wherein the at least one processor is further configured to provide the first prospective customer with an interface to select a financial institution from a list of a plurality of financial institutions, the plurality of financial institutions including the first financial institution and the second financial institution.

In Example 14, the subject matter of Example 8 optionally includes wherein the first prospective customer is a fund manager, a consumer banking customer, or a credit card customer.

Example 15 is a non-transitory computer-readable storage medium, the non-transitory computer-readable storage medium including instructions that when executed by computers, cause the computers to perform operations of: accessing, by a first financial institution, onboarding request data from a computing device associated with a first prospective customer, the onboarding request data comprising identifier data describing the first prospective customer, using the identifier data to identify a block of a distributed ledger comprising first data describing the first prospective customer, the first data provided to the distributed ledger by a second financial institution different than the first financial institution, executing, by the first financial institution, a fraud screening of the first prospective customer using the identifier data and the first data, determining, by the first financial institution, whether the first prospective customer meets onboarding criteria based on the fraud screening, based on determining that the first prospective customer meets the onboarding criteria, creating an account opening gateway for the first prospective customer, and opening an account at the first financial institution for the first prospective customer in response to the onboarding request data using the account opening gateway.

In Example 16, the subject matter of Example 15 optionally includes wherein the distributed ledger is a tiered distributed ledger.

In Example 17, the subject matter of Example 16 optionally includes wherein the instructions cause the computers to perform further operations of using the identifier data to identify a first block of the tiered distributed ledger, and verifying the first block of the distributed ledger.

In Example 18, the subject matter of Example 17 optionally includes wherein the instructions cause the computers to perform further operations of using the identifier data to identify a second block of the distributed ledger comprising second data describing the first prospective customer different than the first data, the second data being encrypted, accessing first cryptographic key data associated with the second block of the distributed ledger, and decrypting the second data using the first cryptographic key data.

In Example 19, the subject matter of Example 18 optionally includes wherein the instructions cause the computers to perform further operations of executing, by the first financial institution, a fraud screening of the first prospective customer using the first data and the second data.

In Example 20, the subject matter of Example 15 optionally includes wherein the instructions cause the computers to perform further operations of providing the first prospective customer with an interface to select a financial institution from a list of a plurality of financial institutions, the plurality of financial institutions including the first financial institution and the second financial institution.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A computer-implemented method comprising:
accessing, by a first financial institution system of a first financial institution, onboarding request data from a computing device associated with a first prospective customer, the onboarding request data comprising identifier data describing the first prospective customer;
using the identifier data to identify a block of a distributed ledger comprising first data describing the first prospective customer, the first data provided to the distributed ledger by a second financial institution system of a second financial institution different than the first financial institution system, wherein the first data includes results of a due diligence screening of the first prospective customer performed by the second financial institution;
executing, by the first financial institution system, a fraud screening of the first prospective customer using the identifier data and the first data;
determining, by the first financial institution system, whether the first prospective customer meets onboarding criteria based on the fraud screening;
based on determining that the first prospective customer meets the onboarding criteria, creating an account opening gateway for the first prospective customer; and
opening an account at the first financial institution for the first prospective customer in response to the onboarding request data using the account opening gateway.

2. The computer-implemented method of claim 1, wherein the distributed ledger is a tiered distributed ledger.

3. The computer-implemented method of claim 2, further comprising:
using the identifier data to identify a first block of the tiered distributed ledger; and
verifying the first block of the distributed ledger.

4. The computer-implemented method of claim 3, further comprising:
using the identifier data to identify a second block of the distributed ledger comprising second data describing the first prospective customer different than the first data, the second data being encrypted;
accessing first cryptographic key data associated with the second block of the distributed ledger; and
decrypting the second data using the first cryptographic key data.

5. The computer-implemented method of claim 4, further comprising:
executing, by the first financial institution system, a fraud screening of the first prospective customer using the first data and the second data.

6. The computer-implemented method of claim 1, further comprising:
providing the first prospective customer with an interface to select a financial institution from a list of a plurality of financial institutions, the plurality of financial institutions including the first financial institution and the second financial institution.

7. The computer-implemented method of claim 1, further comprising:
performing analytics on data encoded in at least one block of the distributed ledger to establish a new metric for evaluating risk of onboarding prospective customers.

8. A system comprising:
a computer comprising at least one processor and a data storage device in communication with the at least one processor, wherein the data storage device comprises instructions thereon that, when executed by the at least one processor, causes the at least one processor to:
access, by a first financial institution, onboarding request data from a computing device associated with a first prospective customer, the onboarding request data comprising identifier data describing the first prospective customer;
use the identifier data to identify a block of a distributed ledger comprising first data describing the first prospective customer, the first data provided to the distributed ledger by a second financial institution different than the first financial institution, wherein the first data includes results of a due diligence screening of the first prospective customer performed by the second financial institution;
execute, by the first financial institution, a fraud screening of the first prospective customer using the identifier data and the first data;
determine, by the first financial institution, whether the first prospective customer meets onboarding criteria based on the fraud screening;
based on determining that the first prospective customer meets the onboarding criteria, create an account opening gateway for the first prospective customer; and
open an account at the first financial institution for the first prospective customer in response to the onboarding request data using the account opening gateway.

9. The system of claim 8, wherein the distributed ledger is a tiered distributed ledger.

10. The system of claim 9, wherein the at least one processor is further configured to:
use the identifier data to identify a first block of the tiered distributed ledger; and
verify the first block of the distributed ledger.

11. The system of claim 10, wherein the at least one processor is further configured to:
use the identifier data to identify a second block of the distributed ledger comprising second data describing the first prospective customer different than the first data, the second data being encrypted;
access first cryptographic key data associated with the second block of the distributed ledger; and
decrypt the second data using the first cryptographic key data.

12. The system of claim 11, wherein the at least one processor is further configured to:
execute, by the first financial institution, a fraud screening of the first prospective customer using the first data and the second data.

13. The system of claim 8, wherein the at least one processor is further configured to:
provide the first prospective customer with an interface to select a financial institution from a list of a plurality of financial institutions, the plurality of financial institutions including the first financial institution and the second financial institution.

14. The system of claim 8, wherein the first prospective customer is a fund manager, a consumer banking customer, or a credit card customer.

15. A non-transitory computer-readable storage medium, the non-transitory computer-readable storage medium including instructions that when executed by computers, cause the computers to perform operations of:
accessing, by a first financial institution, onboarding request data from a computing device associated with a first prospective customer, the onboarding request data comprising identifier data describing the first prospective customer;
using the identifier data to identify a block of a distributed ledger comprising first data describing the first prospective customer, the first data provided to the distributed ledger by a second financial institution different than the first financial institution, wherein the first data includes results of a due diligence screening of the first prospective customer performed by the second financial institution;
executing, by the first financial institution, a fraud screening of the first prospective customer using the identifier data and the first data;
determining, by the first financial institution, whether the first prospective customer meets onboarding criteria based on the fraud screening;
based on determining that the first prospective customer meets the onboarding criteria, creating an account opening gateway for the first prospective customer; and
opening an account at the first financial institution for the first prospective customer in response to the onboarding request data using the account opening gateway.

16. The non-transitory computer-readable storage medium of claim 15, wherein the distributed ledger is a tiered distributed ledger.

17. The non-transitory computer-readable storage medium of claim 16, wherein the instructions cause the computers to perform further operations of:
using the identifier data to identify a first block of the tiered distributed ledger; and
verifying the first block of the distributed ledger.

18. The non-transitory computer-readable storage medium of claim 17, wherein the instructions cause the computers to perform further operations of:
using the identifier data to identify a second block of the distributed ledger comprising second data describing the first prospective customer different than the first data, the second data being encrypted;
accessing first cryptographic key data associated with the second block of the distributed ledger; and
decrypting the second data using the first cryptographic key data.

19. The non-transitory computer-readable storage medium of claim 18, wherein the instructions cause the computers to perform further operations of:
executing, by the first financial institution, a fraud screening of the first prospective customer using the first data and the second data.

20. The non-transitory computer-readable storage medium of claim 15, wherein the instructions cause the computers to perform further operations of:
providing the first prospective customer with an interface to select a financial institution from a list of a plurality of financial institutions, the plurality of financial institutions including the first financial institution and the second financial institution.
